(19) United States
(12) Patent Application Publication
(10) Pub. No.: US 2013/0050209 A1
(43) Pub. Date: Feb. 28, 2013

(54) COMPUTING DEVICE, STORAGE MEDIUM AND METHOD FOR DISPLAYING DRAWINGS SYNCHRONOUSLY USING THE SAME

(71) Applicants: CHIH-KUANG CHANG, Tu-Cheng (TW); XIN-YUAN WU, Shenzhen City (CN); MIN WANG, Shenzhen City (CN)

(72) Inventors: CHIH-KUANG CHANG, Tu-Cheng (TW); XIN-YUAN WU, Shenzhen City (CN); MIN WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/494,958

(22) Filed: Jun. 12, 2012

(30) Foreign Application Priority Data
Aug. 25, 2011 (CN) 201110245693.7

(51) Int. Cl. G06T 17/00

(52) U.S. Cl. 345/420

(57) ABSTRACT

A two-dimensional (2D) drawing and a three-dimensional (3D) drawing of a product are displayed in a 2D view space and a 3D view space of a 3D offline programming software on a display device. A 3D view matrix and a 2D view matrix are calculated. A compensation matrix is calculated. A current view matrix of the 3D view space and a current view matrix of the 2D view space are calculated. A first view space where displays a cursor is defined as a current view space, and a second view space is defined as a synchronous view space. A synchronous matrix of the current view space is calculated. An update matrix that updates the drawing displayed in the synchronous view space is calculated. The drawing displayed in the synchronous view space of the display device is updated by multiplying the update matrix and coordinates of the drawing.

### BACKGROUND

1. Technical Field

Embodiments of the present disclosure relate to computing devices and methods for displaying drawings, and more particularly to a computing device, a storage medium, and a method for displaying drawings synchronously using the computing device.

2. Description of Related Art

When using a computing device to write three-dimensional (3D) offline measurement programs of a product, a computer-aided design (CAD) software and a 3D offline programming software are used. The CAD software is used for displaying a two-dimensional (2D) drawing of the product that include measurements and identifiers of measurement elements of the product. After a 3D drawing of the product in a CAD format is imported into the 3D offline programming software, the designers can write the measurement programs using the 3D offline programming software according to the 2D drawing and the 3D drawing.

However, since the 2D drawing displayed in the CAD software and the 3D drawing displayed in the 3D offline programming software cannot be displayed synchronously, such as if the 2D drawing or the 3D drawing are rotated or moved, it is inconvenient for the designers to find the corresponding measurement elements in the 2D drawing or the 3D drawing.

### BRIEF DESCRIPTION OF THE DRAWINGS

FIG. 1 is a block diagram of one embodiment of a computing device including a drawing displaying system.

FIG. 2 is a schematic diagram of one embodiment of view spaces of a three-dimensional offline programming software.

FIG. 3 is a flowchart of one embodiment of a method for displaying drawings synchronously using the computing device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

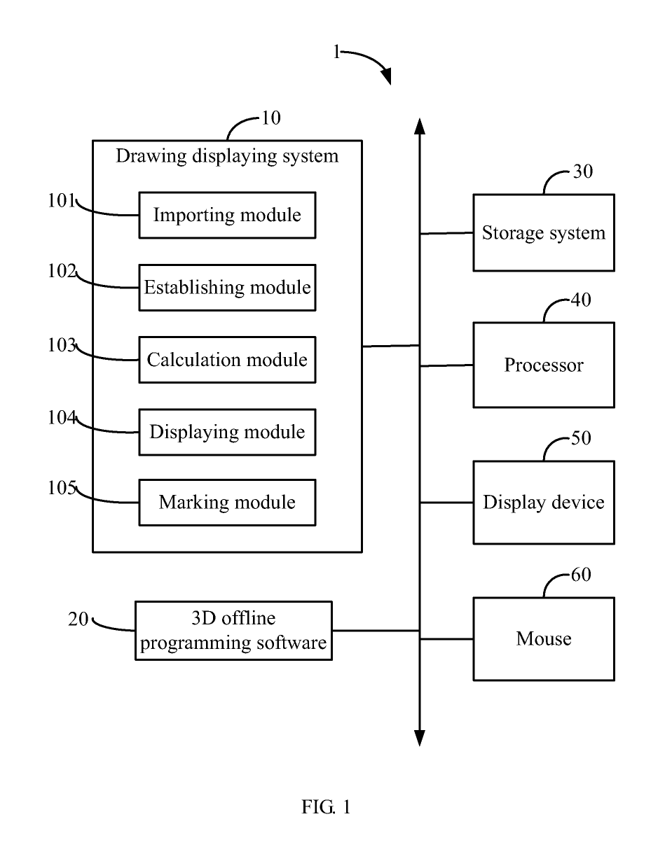

FIG. 1 is a block diagram of one embodiment of a computing device 1 including a drawing displaying system 10. In the embodiment, the computing device 1 further includes a three-dimensional (3D) offline programming software 20, a storage system 30, at least one processor 40, a display device 50, and a mouse 60. The storage system 30 stores a two-dimensional (2D) drawing and a 3D drawing of a product in a computer-aided design (CAD) format. The 2D drawing of the product indicates measurements and identifiers of measurement elements of the product. For example, the measurement elements may be points, lines, planes, and circles of the product. The display device 50 displays view spaces of the 3D offline programming software 20. The view spaces are respectively used to display the 2D drawing and the 3D drawing in the 3D offline programming software 20. FIG. 1 is just one example of the computing device 1 that can be included with more or fewer components than shown in other embodiments, or have a different configuration of the various components.

The drawing displaying system 10 may be in a form of one or more programs that are stored in the storage system 30 and executed by the at least one processor 40. The drawing displaying system 10 can control the 2D drawing and the 3D drawing of the product to be displayed synchronously in the view spaces of the 3D offline programming software 20. For example, when the 3D drawing is rotated using the mouse 60 by a user of the computing device 1, the drawing displaying system 10 can control the 2D drawing to be rotated synchronously with the 3D drawing, so that the 2D drawing and the 3D drawing can display the same measurement elements of the product.

In one embodiment, the storage system 30 may be a random access memory for temporary storage of information, and/or a read only memory for permanent storage of information. In other embodiments, the storage system 30 may also be an external storage device, such as a hard disk, a storage card, or a data storage medium. The at least one processor 40 executes computerized operations of the computing device 1 to provide functions of the computing device 1.

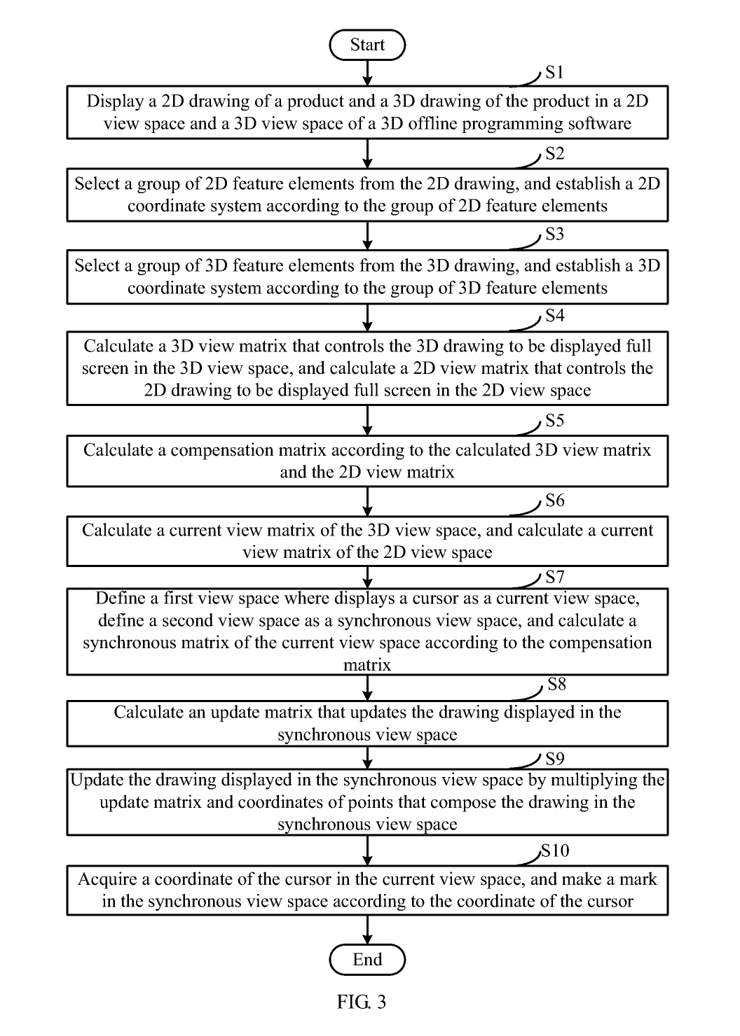

In one embodiment, the drawing displaying system 10 may include an importing module 101, an establishing module 102, a calculation module 103, a displaying module 104, and a marking module 105. The module 101-105 may comprise a plurality of functional modules each comprising one or more programs or computerized codes that are stored in the storage system 30. The computerized code includes instructions that are executed by the at least one processor 40 to provide the functions mentioned below of the one or more modules 101-105 illustrated in FIG. 3.

FIG. 3 is a flowchart of one embodiment of a method for displaying drawings synchronously using the computing device 1 of FIG. 1. Depending on the embodiment, additional steps may be added, others removed, and the ordering of the steps may be changed.

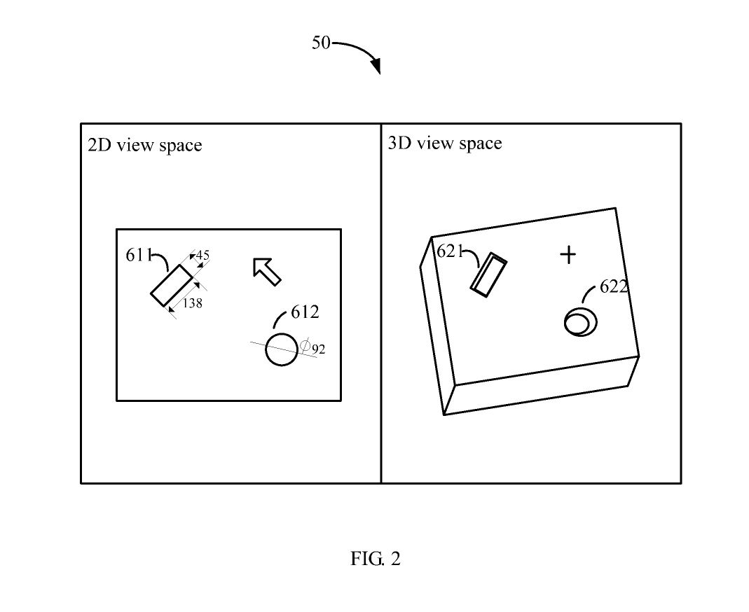

In step S1, the importing module 101 displays a 2D drawing of the product from the storage system 30 in a 2D view space of the 3D offline programming software 20, and displays a 3D drawing of the product from the storage system 30 in a 3D view space of the 3D offline programming software 20. Referring to FIG. 2, the 2D drawing includes a group of 2D feature elements of the product, such as a square 611 and a circle 612. The 3D drawing includes a group of 3D feature elements of the product, such as a square hole 621 and a circle hole 622.

In step S2, the establishing module 102 establishes a 2D coordinate system in the 2D view space. In one embodiment, the establishing module 102 selects a group of 2D feature elements from the 2D drawing. The group of 2D feature elements can identify a unique position of the 2D drawing. The establishing module 102 establishes the 2D coordinate system according to the group of 2D feature elements.

In step S3, the establishing module 102 further establishes a 3D coordinate system in the 3D view space that corresponds to the 2D coordinate system. The establishing module 102 selects a group of 3D feature elements corresponding to the group of 2D feature elements from the 3D drawing. For example, the square hole 621 may correspond to the square 611, and the circle hole 622 may correspond to the circle 612. The establishing module 102 establishes the 3D coordinate system according to the group of 3D feature elements. A coordinate value of a position of the product in the 2D coordinate system is the same as a coordinate value of the position in the 3D coordinate system.

In step S4, the calculation module 103 calculates a 3D view matrix that controls the 3D drawing to be displayed full screen in the 3D view space. A detailed description of the method of calculating the 3D view matrix will be given in the following paragraphs.

In detail, the calculation module 103 firstly calculates a rotation matrix of the 3D drawing (hereinafter, 3D rotation matrix for short). The 3D rotation matrix is defined as a matrix that is used to rotate the 3D drawing in the 3D view space. In one embodiment, the method of calculating the 3D rotation matrix is given as follows: (1) the calculation module 103 finds a normal vector “V1” of a Z-axis of the 3D coordinate system, and determines a coordinate of the normal vector “V1” as (V1.x, V1.y, V1.z); (2) the calculation module 103 finds a normal vector “V2” of a screen of the display device 50, and determines a coordinate of the normal vector “V2” as (V2.x, V2.y, V2.z); (3) the calculation module 103 calculates an angle “A” between the normal vector “V1” and the normal vector “V2” according to a formula as follows:

$$A = a cos ( \frac{V 1. x * V 2. x + V 1. y * V 2. y + V 1. z * V 2. z}{\sqrt{( V 1. {x}^{2} + V 1. {y}^{2} + V 1. {z}^{2} ) * ( V 2. {x}^{2} + V 2. {y}^{2} + V 2. {z}^{2} )}} ) ;$$

(4) the calculation module 103 calculates a coordinate of a normal vector “V” that is perpendicular to the normal vector “V1” and the normal vector “V2”. The formulas of calculating the coordinate of the normal vector “V” is given as follows:

V.x=V1.y*V2.z−V2.y*V1.z

V.y=V1.z*V2.x−V2.z*V1.x

V.z=V1.x*V2.y−V2.x*V1.y;

(5) the calculation module 103 calculates the 3D rotation matrix “rotate3D” according to a 3D composite transformation formula as follows:

$$rotate 3 D = [ \begin{matrix}cos A + ( 1 - cos A ) V . {x}^{2} & ( 1 - cos A ) V . xV . y - ( sin A ) V . z & ( 1 - cos A ) V . xV . z + ( sin A ) V . y \\ ( 1 - cos A ) V . yV . z + ( sin A ) V . z & cos A + ( 1 - cos A ) V . {y}^{2} & ( 1 - cos A ) V . yV . z - ( sin A ) V . x \\ ( 1 - cos A ) V . zV . x - ( sin A ) V . y & ( 1 - cos A ) V . zV . y + ( sin A ) V . x & cos A + ( 1 - cos A ) V . {z}^{2}\end{matrix} ]$$

Secondly, the calculation module 103 calculates a move matrix of the 3D drawing (hereinafter, 3D move matrix for short). The 3D move matrix is defined as a matrix that is used to move the 3D drawing in the 3D view space. In one embodiment, the method of calculating the 3D move matrix is given as follows: (1) the calculation module 103 finds a center “Pt1” of the 3D drawing and determines a coordinate of the center “Pt1” as (Pt1.x, Pt1.y, Pt1.z). In the embodiment, the 3D drawing is composed of a plurality of points. The “Pt1.x” is an average of X-axis coordinates of the points in the 3D coordinate system, the “Pt1.y” is an average of Y-axis coordinates of the points in the 3D coordinate system, and the “Pt1.z” is an average of Z-axis coordinates of the points in the 3D coordinate system. (2) The calculation module 103 finds a center “Pt2” of the 3D view space and determines a coordinate of the center “Pt2” as (Pt2.x, Pt2.y, Pt2.z). The “Pt2.x” is an average of a maximum X-axis coordinate and a minimum X-axis coordinate of the 3D view space in the 3D coordinate system, the “Pt2.y” is an average of a maximum Y-axis coordinate and a minimum Y-axis coordinate of the 3D view space in the 3D coordinate system, and the “Pt2.z” is an average of a maximum Z-axis coordinate and a minimum Z-axis coordinate of the 3D view space in the 3D coordinate system. (3) The calculation module 103 calculates the 3D move matrix “move3D” according to formulas as follows:

move3D[0][3]=Pt2.x−Pt1.x

move3D[1][3]=Pt2.y−Pt1.y

move3D[2][3]=Pt2.z−Pt1.z.

Thirdly, the calculation module 103 calculates a scaling matrix of the 3D drawing (hereinafter, 3D scaling matrix for short). The 3D scaling matrix is defined as a matrix that is used to scale the 3D drawing in the 3D view space. In one embodiment, the method of calculating the 3D scaling matrix is given as follows: (1) the calculation module 103 finds a maximum point “maxPt” and a minimum point “minPt” of the 3D drawing, determines a coordinate of the maximum point “maxPt” as (Xmax, Ymax, Zmax), and determines a coordinate of the minimum point “minPt” as (Xmin, Ymin, Zmin). As mentioned above, the 3D drawing is composed of the plurality of points. The “Xmax” is a maximum X-axis coordinate of the points, the “Ymax” is a maximum Y-axis coordinate of the points, the “Zmax” is a maximum Z-axis coordinate of the points, the “Xmin” is a minimum X-axis coordinate of the points, the “Ymin” is a minimum Y-axis coordinate of the points, the “Zmin” is a minimum Z-axis coordinate of the points in the 3D coordinate system. (2) The calculation module 103 acquires a coordinate of a point “minPt1” by multiplying the coordinate of the “minPt” and the 3D rotation matrix together, acquires a coordinate of a point “maxPt1” by multiplying the coordinate of the “maxPt” and the 3D rotation matrix together, and acquires coordinates of points “minPt2” and “maxPt2” in a display coordinate system of the 3D view space that correspond to the points “minPt1” and “maxPt1” in the 3D coordinate system. The display coordinate system is defined as a coordinate system where objects are transformed to before being displayed in the view spaces of the 3D offline programming software 20. (3) The calculation module 103 calculates a difference of the X-axis coordinate between the point “minPt2” and “maxPt2”, and calculates a difference of the Y-axis coordinate between the point “minPt2” and “maxPt2”. The calculation module 103 further selects a difference “D” with a larger number from the difference of the X-axis coordinate and the difference of the Y-axis coordinate. (4) The calculation module 103 calculates the 3D scaling matrix “scaling3D” according to formulas as follows:

scale3D[0][0]=1/D

scale3D[1][1]=1/D

scale3D[2][2]=1/D

Finally, the calculation module 103 calculates the 3D view matrix by multiplying the 3D rotation matrix, the 3D move matrix, and the 3D scaling matrix together. As mentioned above, the 3D view matrix=rotate3D*move3D*scale3D.

The calculation module 103 further calculates a 2D view matrix that controls the 2D drawing to be displayed full screen in the 2D view space. The calculation module 103 calculates the 2D view matrix by multiplying a move matrix of the 2D drawing (hereinafter, 2D move matrix for short) and a scaling matrix of the 2D drawing (hereinafter, 2D scaling matrix for short) together. In the embodiment, the method of calculating the 2D move matrix is the same as the method mentioned above of calculating the 3D move matrix. The method of calculating the 2D scaling matrix is the same as the method mentioned above of calculating the 3D scaling matrix.

In step S5, the calculation module 103 further calculates a compensation matrix according to the calculated 3D view matrix and the 2D view matrix. The compensation matrix indicates a difference between the 3D view matrix and the 2D view matrix.

In step S6, the calculation module 103 calculates a current view matrix of the 3D view space (hereinafter, 3D current view matrix for short) and a current view matrix of the 2D view space ((hereinafter, 2D current view matrix for short). The 3D current view matrix is defined as a matrix that controls the 3D drawing to be rotated, moved, or scaled according to operations of the mouse 60 in the 3D view space. The method of calculating the 3D current view matrix is the same as the method of calculating the 3D view matrix. The 3D current view matrix can be acquired by multiplying a 3D current rotation matrix, a 3D current move matrix, and a 3D current scaling matrix together. The methods of calculating the 3D current rotation matrix, the 3D current move matrix, and the 3D current scaling matrix are given as below.

In detail, when a cursor of the mouse 60 is dragged in the 3D view space, the calculation module 103 finds a point “Pt3” in the 3D coordinate system according to the cursor when the primary button of the mouse 60 is pressed, and finds a point “Pt4” in the 3D coordinate system according to the cursor when the primary button of the mouse 60 is released. A vector from the point “Pt3” to the point “Pt4” is defined as the normal vector “V1”. A vector that is perpendicular to the normal vector “V1” and the normal vector “V2” of the screen of the display device 50 is defined as the normal vector “V”. An angle between the normal vector “V1” and the normal vector “V2” is defined as the angle “A”. Referring to the formula of calculating the 3D rotation matrix, the calculation module 103 can calculate the 3D current rotation matrix. If replacing the center “Pt1” with the point “Pt3’, and replacing the center “Pt2” with the point “Pt4”, referring to the formula of calculating the 3D move matrix, the calculation module 103 can calculate the 3D current move matrix. If a distance between the point “Pt3” and the point “Pt4” is defined as the difference “D”, referring to the formula of calculating the 3D scaling matrix, the calculation module 103 can calculate the 3D current scaling matrix.

The 2D current view matrix is defined as a matrix that controls the 2D drawing to be moved or scaled according to operations of the mouse 60 in the 2D view space. The 2D current view matrix can be acquired by multiplying a 2D current move matrix and a 2D current scaling matrix together. The method of calculating the 2D current move matrix is the same as the method of calculating the 3D current move matrix. The method of calculating the 2D current scaling matrix is the same as the method of calculating the 3D current scaling matrix.

In step S7, the calculation module 103 defines one of the 2D view space and the 3D view space where the cursor of the mouse 60 is displayed as a current view space, and defines the other view space as a synchronous view space. For example, if the cursor of the mouse 60 is displayed in the 2D view space, the 2D view space is defined as the current view space, and the 3D view space is defined as the synchronous view space. The calculation module 103 calculates a synchronous matrix of the current view space according to the compensation matrix.

If the current view space is the 3D view space, the synchronous matrix of the current view space is equal to a difference between the 3D current view matrix and the compensation matrix. If the current view space is the 2D view space, the synchronous matrix of the current view space is equal to a sum of the 2D current view matrix and the compensation matrix.

In step S8, the calculation module 103 calculates an update matrix that updates the drawing displayed in the synchronous view space. The update matrix can be calculated by multiplying the synchronous matrix of the current view space and the current view matrix of the synchronous view space. For example, if the current view space is the 2D view space, and the synchronous view space is the 3D view space, the update matrix can be calculated by multiplying the synchronous matrix of the 2D view space and the 3D current view matrix.

In step S9, the displaying module 104 updates the drawing displayed in the synchronous view space by multiplying the update matrix and the coordinates of the points of the drawing in the synchronous view space. The drawing in the synchronous view space can be displayed synchronously with the drawing in the current view space.

In step S10, the marking module 105 acquires coordinates of the cursor in the coordinate system of the current view space, and makes a mark in the synchronous view space according to the coordinates of the cursor in the coordinate system of the current view space. The mark may be a symbol “+,” for example. Referring to FIG. 2, the 2D view space displays the cursor “ [symbol] ,” and the 3D view space displays the mark “+” corresponding to the cursor “ [symbol] ,” When the cursor moves in the current view space, the mark moves synchronously with the cursor in the synchronous view space. If the cursor indicates a position in the current view space, the mark indicates the same position in the synchronous view space. For example, if the cursor indicates the square 611 in the 2D view space, the mark indicates the square hole 621 in the 3D view space.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a storage system that stores a two-dimensional (2D) drawing of a product and a three-dimensional (3D) of the product in a computer-aided design format;
at least one processor;
a 3D offline programming software that displays a 2D view space and a 3D view space on a display device of the computing device; and
one or more programs stored in the storage system and executed by the at least one processor, the one or more programs comprising:
an importing module that displays the 2D drawing from the storage system in the 2D view space on the display device and displays the 3D drawing from the storage system in the 3D view space on the display device;
a calculation module that calculates a 3D view matrix that controls the 3D drawing to be displayed full screen in the 3D view space, and calculates a 2D view matrix that controls the 2D drawing to be displayed full screen in the 2D view space;
the calculation module further calculating a compensation matrix according to the calculated 3D view matrix and the 2D view matrix;
the calculation module further calculating a current view matrix of the 3D view space that controls the 3D drawing to be rotated, moved, or scaled in the 3D view space, and calculates a current view matrix of the 2D view space that controls the 2D drawing to be moved or scaled in the 2D view space;
the calculation module further defining a first view space where a cursor of a mouse of the computing device is displayed as a current view space of the display device, defines a second view space of the display device as a synchronous view space, and calculates a synchronous matrix of the current view space according to the compensation matrix;
the calculation module further calculating an update matrix that updates the drawing displayed in the synchronous view space according to the synchronous matrix of the current view space and the current view matrix of the synchronous view space; and
a display module that updates the drawing displayed in the synchronous view space by multiplying the update matrix and coordinates of points that compose the drawing in the synchronous view space.

2. The computing device of claim 1, further comprising:
an establishing module that establishes a 2D coordinate system in the 2D view space and establishes a 3D coordinate system in the 3D view space, wherein a coordinate value of a position of the product in the 2D coordinate system is the same as a coordinate value of the position in the 3D coordinate system.

3. The computing device of claim 1, wherein the 3D view matrix is calculated by multiplying a rotation matrix of the 3D drawing, a move matrix of the 3D drawing, and a scaling matrix of the 3D drawing, and the 2D view matrix is calculated by multiplying a move matrix of the 2D drawing and a scaling matrix of the 2D drawing.

4. The computing device of claim 1, wherein the compensation matrix is a matrix that indicates a difference between the 3D view matrix and the 2D view matrix.

5. The computing device of claim 1, wherein the synchronous matrix of the current view space is equal to a difference between the 3D current view matrix and the compensation matrix if the current view space is the 3D view space, and the synchronous matrix of the current view space is equal to a sum of the 2D current view matrix and the compensation matrix if the current view space is the 2D view space.

6. The computing device of claim 1, wherein the update matrix is calculated by multiplying the synchronous matrix of the current view space and the current view matrix of the synchronous view space.

7. The computing device of claim 1, wherein the one or more programs further comprises:
a marking module that acquires a coordinate of the cursor in the current view space of the display device, and makes a mark in the synchronous view space according to the coordinate of the cursor.

8. A method of a computing device for displaying drawings synchronously, the computing device comprising a storage system, a display device, and a three-dimensional (3D) offline programming software, the method comprising:
displaying a two-dimensional (2D) view space and a 3D view space on the display device using the 3D offline programming software;
displaying the 2D drawing from the storage system in the 2D view space on the display device, and displaying the 3D drawing from the storage system in the 3D view space on the display device;
calculating a 3D view matrix that controls the 3D drawing to be displayed full screen in the 3D view space, and calculating a 2D view matrix that controls the 2D drawing to be displayed full screen in the 2D view space;
calculating a compensation matrix according to the calculated 3D view matrix and the 2D view matrix;
calculating a current view matrix of the 3D view space that controls the 3D drawing to be rotated, moved, or scaled in the 3D view space, and calculating a current view matrix of the 2D view space that controls the 2D drawing to be moved or scaled in the 2D view space;
defining a first view space where a cursor of a mouse of the computing device is displayed as a current view space of the display device, defining a second view space as a synchronous view space of the display device, and calculating a synchronous matrix of the current view space according to the compensation matrix;
calculating an update matrix that updates the drawing displayed in the synchronous view space according to the synchronous matrix of the current view space and the current view matrix of the synchronous view space; and
updating the drawing displayed in the synchronous view space by multiplying the update matrix and coordinates of points that compose the drawing in the synchronous view space.

9. The method of claim 8, further comprising:
establishing a 2D coordinate system in the 2D view space; and
establishing a 3D coordinate system in the 3D view space, wherein a coordinate value of a position of the product in the 2D coordinate system is the same as a coordinate value of the position in the 3D coordinate system.

10. The method of claim 8, wherein the compensation matrix is a matrix that indicates a difference between the 3D view matrix and the 2D view matrix.

11. The method of claim 8, wherein the synchronous matrix of the current view space is equal to a difference between the 3D current view matrix and the compensation matrix if the current view space is the 3D view space, and the synchronous matrix of the current view space is equal to a sum of the 2D current view matrix and the compensation matrix if the current view space is the 2D view space.

12. The method of claim 8, wherein the update matrix is calculated by multiplying the synchronous matrix of the current view space and the current view matrix of the synchronous view space.

13. The method of claim 8, further comprising:
acquiring a coordinate of the cursor in the current view space of the display device; and
making a mark in the synchronous view space according to the coordinate of the cursor.

14. A non-transitory storage medium storing a set of instructions, the set of instructions capable of being executed by a processor of a computing device, causes the computing device to execute a method for displaying drawings synchronously, the computing device comprising a storage system, a display device, and a three-dimensional (3D) offline programming software, the method comprising:
displaying a two-dimensional (2D) view space and a 3D view space on the display device using the 3D offline programming software;
displaying the 2D drawing from the storage system in the 2D view space on the display device and displaying the 3D drawing from the storage system in the 3D view space on the display device;
calculating a 3D view matrix that controls the 3D drawing to be displayed full screen in the 3D view space, and calculating a 2D view matrix that controls the 2D drawing to be displayed full screen in the 2D view space;
calculating a compensation matrix according to the calculated 3D view matrix and the 2D view matrix;
calculating a current view matrix of the 3D view space that controls the 3D drawing to be rotated, moved, or scaled in the 3D view space, and calculating a current view matrix of the 2D view space that controls the 2D drawing to be moved or scaled in the 2D view space;
defining a first view space where a cursor of a mouse of the computing device is displayed as a current view space of the display device, defining a second view space as a synchronous view space of the display device, and calculating a synchronous matrix of the current view space according to the compensation matrix;
calculating an update matrix that updates the drawing displayed in the synchronous view space according to the synchronous matrix of the current view space and the current view matrix of the synchronous view space; and
updating the drawing displayed in the synchronous view space by multiplying the update matrix and coordinates of points that compose the drawing in the synchronous view space.

15. The storage medium of claim 14, wherein the method further comprising:
establishing a 2D coordinate system in the 2D view space; and
establishing a 3D coordinate system in the 3D view space, wherein a coordinate value of a position of the product in the 2D coordinate system is the same as a coordinate value of the position in the 3D coordinate system.

16. The storage medium of claim 14, wherein the compensation matrix is a matrix that indicates a difference between the 3D view matrix and the 2D view matrix.

17. The storage medium of claim 14, wherein the synchronous matrix of the current view space is equal to a difference between the 3D current view matrix and the compensation matrix if the current view space is the 3D view space, and the synchronous matrix of the current view space is equal to a sum of the 2D current view matrix and the compensation matrix if the current view space is the 2D view space.

18. The storage medium of claim 14, wherein the update matrix is calculated by multiplying the synchronous matrix of the current view space and the current view matrix of the synchronous view space.

19. The storage medium of claim 14, wherein the method further comprising:
acquiring a coordinate of the cursor in the current view space of the display device; and
making a mark in the synchronous view space according to the coordinate of the cursor.
